(19) United States
(12) Patent Application Publication
(10) Pub. No.: US 2006/0045980 A1
(43) Pub. Date: Mar. 2, 2006

(54) Method and apparatus for application of a finish to a lineal product

(76) Inventors: Aaron H. Johnson, Fargo, ND (US); Todd Pringle, West Fargo, ND (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 11/209,343

(22) Filed: Aug. 23, 2005

Related U.S. Application Data
(60) Provisional application No. 60/603,619, filed on Aug. 23, 2004.

(51) Int. Cl. B05D 3/02

(52) U.S. Cl. 427/372.2

(57) ABSTRACT

A method includes forming a lineal substrate in a production line, die-applying a thermoset finish to a surface of the lineal substrate inline, and curing the thermoset finish inline so as to bond the thermoset finish to the surface of the lineal substrate.

### CROSS-REFERENCE TO RELATED APPLICATION

This application claims the benefit under 35 U.S.C. 119 (e) of U.S. Provisional Application No. 60/603,619 filed on Aug. 23, 2004, which is hereby incorporated by reference in its entirety.

### FIELD

The present invention relates to forming lineal plastic, lineal composite, or metal products, and more specifically to a finish for a lineal product.

### BACKGROUND

The production of lineal products is well known in their respective arts. For example, a lineal product can be formed by pultrusion, extrusion, or metal rolling a product. The lineal products are formed having a constant profile in a substantially continuous manner in a production line.

These products generally require an aesthetic or functional finish to maximize usability and durability. A finish is a covering, laminate, or coating that goes over the lineal component. For example, a metal lineal requires a finish for corrosion resistance. Also, a bare pultrusion, made with common pultrusion resin systems, is unable to withstand prolonged exposure to outdoor environments. Exterior exposure can cause both the resin matrix and the reinforcing fibers to degrade. Degradation leads to a rapid loss in aesthetic quality and ultimately a loss of structural properties.

There are several methods used to improve the weathering resistance of pultruded products. These methods include the use of high performance resin matrices, surfacing veils, and the addition of stabilizing additives. However, the intrinsic cost to attain durability limits the application of many exterior durable pultrusion systems. A finishing or coating system provides the most durable long-term solution; however, cost-effectively finishing a pultrusion has inherent complexity.

Current methods of continuous in-line coating of structural lineal products involve spray coating, horizontal powder coating, and crosshead extrusion. These coating methods are limited by the natural capability of the processes and materials.

For example, spray application is beset with volatile organic compounds (VOC). VOC is a consumable solvent that is used in the manufacture and application of many coatings. Also, in latex and waterborne spray applications the coating material requires extended time for the coating to level, coalesce, and evaporate residual VOC. Additionally, spray application requires a direct line of sight for application. The necessity of a direct line of sight impedes good surface coverage in complex shapes that can have recessed features. Other troubles with spray coating include drips, leveling, and sagging. Additionally, paint conforms to the geometry of the part and cannot be used to define the shape or a detail feature.

Powder coating is horizontally applied to a vertical component to enable uniform coverage of the substrate. Most horizontal powder coating systems require electrostatic charge to hold the powder particulates in place during melting, leveling, and curing. Because powder coating relies on an electrostatic attraction between the powder and substrate, there is difficulty in application to nonmetallic substrates such as wood, plastic extrusions or pultrusions. Moreover, powder coated in-line systems are limited to following the contour of the composite part and have difficulty achieving uniform coverage in detail areas. Complicated masking is required to have sharp coating edges.

In crosshead coating, a thin layer of thermoplastic or solvent-based coating material is deposited over a lineal substrate. However, thermoplastics are known to have lower capability relative to thermosets in areas of creep, chip resistance, scratch resistance, thermal stability, and solvent resistance.

What is needed is an in-line method to cost-effectively form aesthetically pleasing protective barriers, finish, or detail features on structural lineal products.

### SUMMARY

A method includes forming a lineal substrate in a production line, die-applying a thermoset finish to a surface of the lineal substrate inline, and curing the thermoset finish inline so as to bond the thermoset finish to the surface of the lineal substrate.

### BRIEF DESCRIPTION OF THE DRAWINGS

FIG. 1 is a diagrammatic view of a pultrusion production line that can be used to produce a thermoset finish or detail feature in accordance with one embodiment of the present invention.

FIG. 2 is a fragmented cross-sectional view of a pultrusion produced in accordance with the pultrusion production line illustrated in FIG. 1.

FIG. 3 is side cross-section view of a thermoset finish application die as illustrated in FIG. 1.

FIG. 4 is side cross-section view of an IR oven used to cure a thermoset material, in accordance with one embodiment.

FIG. 5 is a cross-section profile view of a composite product in accordance with one embodiment.

FIG. 6 is as cross-section profile view of a composite product in accordance with one embodiment.

FIG. 7 is a schematic view of an extrusion production line that can be used to produce a thermoset finish or detail feature in accordance with one embodiment of the present invention.

FIG. 8 is as cross-section profile view of a product in accordance with one embodiment.

FIG. 9 is a schematic view of a production line that can be used to produce a thermoset finish or detail feature in accordance with one embodiment of the present invention.

FIG. 10 is as cross-section profile view of a product in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

In some embodiments, the present system pertains to a method for the formation of a pultruded, weather-resistant, reinforced composite. In some examples, this is accomplished by the inline application of a high melt temperature cross-linkable polymer material to form a thermoset finish system.

In some embodiments, the present system encompasses a lineal product made in a continuous process. Examples of lineal products are components based on extrusion of plastic or metal, roll-forming, and pultrusion processes. One embodiment utilizes pultrusion and can be adapted to both continuous and discontinuous methods of applying a thermoset to lineal products. Some embodiments are directed to enhance the durability, aesthetic quality, or provide a detail feature on lineals created in a continuous process.

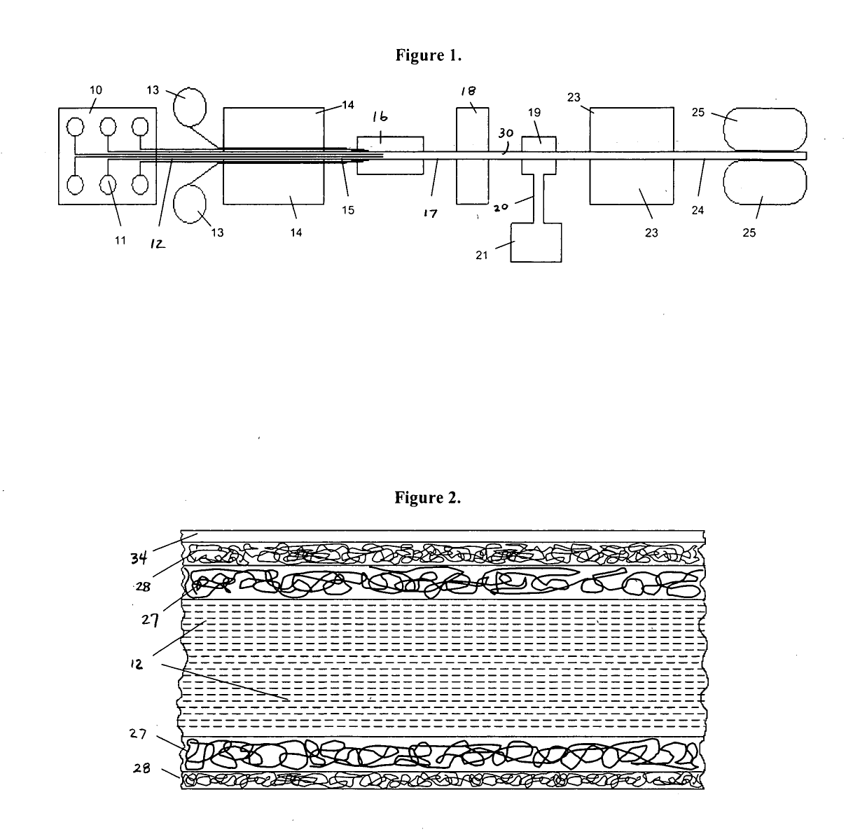

FIG. 1 shows a diagrammatic view of a pultrusion production line, in accordance with one embodiment, for creating a fiber reinforced composite lineal product having a thermoset finish. Pultrusion is a process of making a fiberglass reinforced material where continuous fibers are impregnated with a thermoset or thermoplastic resin and pulled through a curing or setting die. Those skilled in the art will recognize that multiple shapes and sizes are possible using pultrusion and other continuous manufacturing processes.

In one example, the pultrusion process begins on creels 10 that that hold packages 11 of spooled glass rovings. A roving is typically composed of 4,000 to 5,000 glass fibers although variants to this are common. A plurality of rovings 12 are guided from the creels to a forming and resin impregnating fixture 14 where they are combined with rolls 13 of glass or polyester mat (continuous or chopped strand), veils, weave, or combinations of fabric. Typically, roving and mat are treated with chemical sizing to improve compatibility with the matrix resin. The resin impregnated fibers 15 exit the forming zone with the approximate shape of the pultrusion. The resin saturated materials then enter a curing or pultrusion die 16 where the shape of the reinforced composite 17 will be determined. To instigate cure, the pultrusion die 16 is heated in the range of 100 to 700° F. The velocity of the production line process is dictated by a reciprocating clamp or other puller mechanism 25 and a balance of cure rates of the resin matrix. The production line can continuously form lineal products. As will be discussed below, all the components to form the final lineal product are inline (contained within the continually running production line) such that forming the final product requires no further processing.

To apply a thermoset finish or detail feature in a manner that creates the most cost-effective line speed the substrate composite 17 is preheated using an infrared (IR), convection, or combination oven 18. Both medium and short wavelength high intensity IR can be used with the preferred embodiment being short wavelength IR. The length of the preheat oven 18 will be dictated by the line speed, oven intensity, and rate of heat gain by the substrate composite 17. Generally, the preheat oven 18 is between 2 and 15 feet in length. The preheating oven 18 has an additional benefit in that it vaporizes residual monomers that can induce finish defects. The heat carried into a thermoset finish application device 19 will also promote the onset of cure for the thermoset finish onto the pultrusion (or other lineal product). The effective temperature of the preheated substrate is between 200 and 600 degrees F. The preferred temperature is dependent on processing conditions.

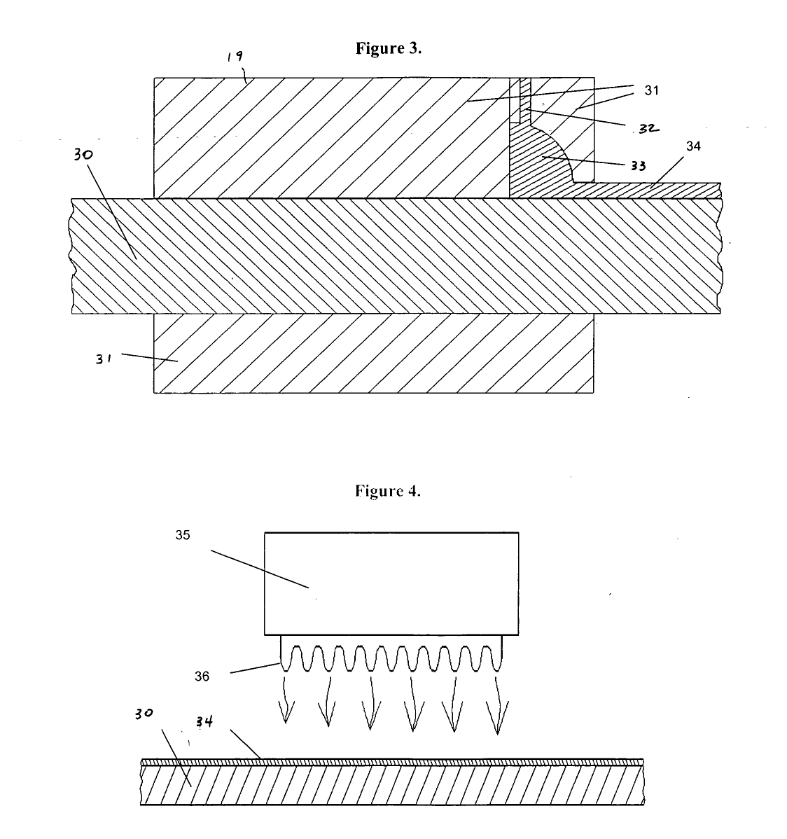

The present system includes die-applying a thermoset finish to a surface of a lineal substrate composite 30 inline. For example, the heated substrate 30 enters application device 19 that is further detailed in FIG. 3, in accordance with one embodiment. Referring to both FIGS. 1 and 3, device 19 includes die blocks 31 that are held at a temperature above the melt temperature of the thermoset finish material 34. The thermoset finish 34 (or a detail feature) is applied inline to the pultruded profile in an application chamber 33 by pressure generated from a high throughput extruder 21. The pressure for application of the thermoset material is in the range of 50 to 3,000 psi depending on the viscosity of the polymer system. The preferred embodiment is a high throughput extruder to minimize the time that the thermoset finish is detained in the melt phase. The extruder 21 is connected by a flow channel 20. Efforts should be made to minimize the volume of finish in the flow channel to minimize time the thermoset finish is in the melt phase before application. In effect, the amount of cure prior to application of the thermoset finish is minimized.

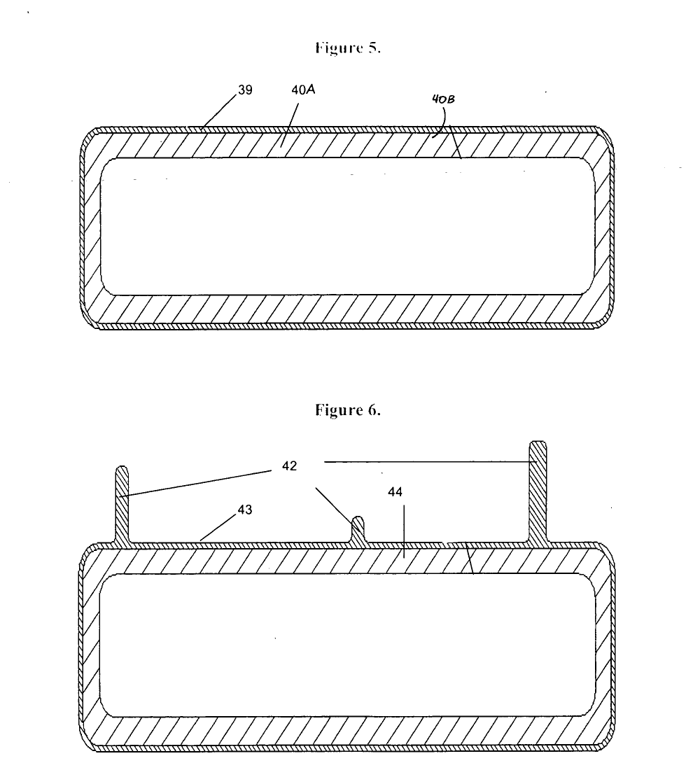

The finishing chamber or die of application device 19 can assume the same shape as part or all of the lineal product. Referring to FIG. 5, which shows a cross-section profile view of a lineal product 40A, in some cases a thermoset finish 39 assumes the shape of the structure of a lineal product substrate 40B.

Referring to FIG. 6, which shows a cross-section profile view of a lineal product, in another example the thermoset finish 43 over the lineal substrate 44 defines the outer shape of the final lineal product by providing one or more detail features 42. A detail feature is anywhere the extruded thermoset finish provides the structure or appendages such as lips, flanges, or channels that were not formed by the pultruded composite or other structural lineal.

In various embodiments, the thermoset finish is advantageously applied with a die geometry that defines the end shape of the product, has no waste byproducts, can be uniformly applied to detail areas, and can provide special effects or detail features that are not achievable with a powder, thermoplastic or liquid finishing application. In some embodiments, the present finishing system applies material precisely in discrete areas and in the details of complex shapes with no wasted or excess finishing material. For example, a strip of thermoset finish can be applied along one side surface of a lineal substrate. The discretely controlled material placement of this die-application system eliminates the need for elaborate masking systems that are necessary with liquid paint or powder coating applications. This easily and effectively eliminates non-coated areas from exposure to the thermosetting finish while applying a predetermined shape or detail feature, amount or thickness of thermosetting finish in designated areas.

Referring again to FIGS. 1 and 3, the thermoset finish can be applied to a solid or hollow lineal substrate. More specifically, chamber 33 and die 31 can assume the shape of the finished lineal in the uncured thermoset material 34. The melt generally follows a flow channel in the die to one or two flow channels 32 around the lineal profile to enable uniform pressure for application of the melt to the lineal profile. In particular, the flow channels 32 are designed to manage a continuous uniform flow of the melted finish and eliminate discontinuous flow regions. Application device 19 can be placed inline at any stage along the length of the lineal production line process; however, it is optimally placed near the pultrusion die 16 to utilize latent heat of the pultrusion process to assist in the cure of the finish.

In one embodiment, after leaving device 19, the uncured thermoset material 34 enters a curing oven 23. The curing oven 23 is heated to temperatures that promote rapid cross-linking. These temperatures range from 200 to 600° F. The length of the oven 23 is dictated by the rate of heating the pultrusion, cure rate of the thermoset polymer, and line speed. A typical oven is on the order of 8 to 40 feet in length. To solidify the product, the finish must be cured and bonded to the outer surface of the composite lineal substrate.

One embodiment of the curing oven is a short wavelength IR oven, although medium wave IR, convection, and combination ovens are also capable. An IR oven 35 is illustrated in FIG. 4. The oven 35 controls IR elements 36 that emit infrared radiation. Subsequently, the thermoset finish material 34 and substrate 30 are heated. The economical line speed and cure characteristics of the thermoset finish dictate the length necessary for the cure oven. Generally, curing the finish requires 2 to 20 minutes. Referring again to FIG. 1, the cured lineal product 24 is then pulled by a pulling machine 25 and fabricated. It should be recognized that finishes with lower and higher melt temperatures, lower and higher melt viscosity, lower and higher cure temperatures, lower and higher cure rates, and alternative curing mechanisms, such as radiation curable systems, may be used with one or more embodiments of this invention.

Some embodiments utilize radiation cure technology including UV, E-Beam, near IR, etc. A radiation emitter can be placed inline anywhere along the path of the lineal product that contains uncured finish. The preferred position is an area of finish with sufficient temperature to assist in the radiation cure.

FIG. 2 shows a cross-section of a composite made by pultrusion, in accordance with one embodiment. In the pultrusion fragment illustrated in FIG. 2, the bulk of the material is composed of rovings 12 oriented in the direction of manufacture or machine direction. Composites generally have maximum strength in directions that align with the glass filaments. In some embodiments, to increase strength in the direction transverse to the machine direction, glass mats or weaves 27 and surface veils 28 are placed near the outside edges of the composite. In some occurrences, mats and weaves are placed in a multitude of layers within the pultrusion along with machine direction rovings. In other instances, the pultrusion is made strictly with mats or weaves. Glass is the typical material used in pultrusion. However, other fibrous materials can be substituted for glass. These materials include, but are not limited to carbon fiber, Kevlar, synthetic polymer fibers, cotton, hemp, wool, and other natural fibers.

To improve durability and increase resistance to weathering, protective thermoset finish 34 is applied inline to the lineal product substrate, such as discussed above. The filaments of the roving and mats are compressed in the pultrusion die 16 and bound by curing the resin matrix; thus, the shape of the composite is created. The resin matrix can have a significant effect on the properties of the pultrusion. One pultrusion resin used in one embodiment is based on unsaturated polyesters cross-linked with styrene. However, other resin systems can be used, these include but are not limited to: vinyl esters, epoxies, phenolics, urethanes, and thermoplastic systems.

It is advantageous to use thermoset materials as finishes because they are known to have superior performance over thermoplastic materials in applications for extreme environments. For this reason, it is desirable to use a thermoset material for the finish.

For example, the viscosity of the thermoset melt is relatively low and affected by shear. This enables improved adhesion due to substrate wet out and penetration to the micro surface defects of the lineal product surface. The post cure will lock the polymer into place on the molecular level and provide superior mechanical adhesion to bond the thermoset finish to the substrate. In lineal systems composed of polymeric materials, latent heteroatoms such as alcohol, carboxylic acid or amine groups can be reacted with functional groups inherent to the finishing system to form chemical adhesion between the finish and the substrate. The cross-linked thermoset finish also provides resistance to solvent swelling and environmental stress cracking. Furthermore, the cross-linking alleviates creep associated with higher temperatures that can cause coating imperfections. In addition, the finish can be zero-VOC. Moreover, the molten thermoset material is capable of forming its own profile or detail features (as defined by the geometry of applicator 19).

In some embodiments, the solid thermosetting finishing technology discussed herein formulates the finish or detail feature using solid components (pigments, fillers, binder, etc.) that are heated and mixed until all the components are melted together and uniformly dispersed. The melted products are then formed into a pellet, kibble, or flake. The pellets are placed into an extruder or hot pressure pot and forced through crosshead die 31 onto the substrate in a continuous in-line process. The term “solid” is used herein to distinguish the solid thermoset finish from powder and solvent systems. Solid refers to its state prior to melting (it does not start as a flowable powder or a liquid paint) and it refers to its state after cure. During processing, it is molten and liquid.

Solid thermoset finishing, as discussed herein, is distinctly different than powder coating technology in the method of application. For example, in powder coatings, the solid mixture is pulverized into a classified powder. Each particle of the powder must contain all the ingredients of the formulation. Powder coatings are generally applied using electrostatic spray, fluidized bed, electrostatic fluidized bed, or flame spray. The difficulty is getting the particles to stay in a uniform layer until they are melted, coalesced together, and cured in an oven. Another common problem is a surface defect called orange peel. This defect is caused by the resin system curing before the particles are entirely coalesced. One more common defect found in powder coatings is caused by surface tension driven flows. Powder coatings are also limited by the glass transition temperature, (T^{g}). The T_{g} must be sufficiently high to avoid particles sintering together during transport and storage. A typical powder will have a T_{g} in the range of but not limited to 100 to 250° F., an extruder processing temperature in the range of but not limited to 100 to 350° F. and be coalesced and cross-linked by baking in the range of but not limited to 150 to 550° F. for 1 to 20 minutes.

In comparison, using a solid thermosetting finish eliminates steps that are necessary in powder coatings. Particle suspension on the substrate, uniform coverage, melt, coalescence, high T_{g}, and several of the surface defects associated with powder coatings are eliminated by the use of solid thermoset finish. Additionally, solid thermosetting finish applied by an inline crosshead die can provide detail features that can not be achieved by a liquid or powder coating system.

There are several chemical classes of solid thermoset finish that can be used according with one or more embodiments. The main classes are described by, but not limited to, the following. The first class is epoxy, mainly Bisphenol A (BPA) or Novolac based with polyamine or phenolics as cross-linkers. A second class is a hybrid acid functional polyester with a BPA epoxy as the cross-linker. Another class is polyester based using an carboxylic acid functional polyester with triglycidylisocyanurate or hydroxyalkybisamides for cross-linkers. Else, hydroxyl functional polyesters are used with blocked isocyanate or amino resins.

Another class is acrylic. These are epoxy functional acrylics cross-linked with dibasic acids or hydroxyl functional acrylics cross-linked with blocked isocyanate or amino resin. In some cases, fluoropolymers are blended into the powder coating material for exceptional durability. One class of coatings are those based on UV-curable resins. These are generally epoxy systems using UV-initiated super acid catalysts. Another type of UV-curing resin uses unsaturated or ring-opening functional groups cured by the use of free radical initiators. Of these classes, the acrylic and polyester are the most UV-durable. However, all of these systems are capable of being implemented by the solid thermoset finishing methods described herein.

The ease of handling a solid material, the ability to cure the finish so as to bond the finish to the substrate, and the elimination of VOC make it beneficial to have a solid thermosetting finish, as described herein.

In one embodiment, a solid thermosetting finish is applied in a molten state to a lineal substrate inline via a die and then thermally cured in an inline oven. One embodiment entails applying an electromagnetic radiation curable solid thermosetting finish in a molten state to a lineal substrate using a die followed by exposure to a radiation source to cure the finish.

In some embodiments, a continuous process for preparing lineal products with a durable finish or detail feature is described. Specifically, a method for forming a fiberglass lineal product from an elongated fibrous material that is impregnated with a curing resin, guided through a forming die, and cured. After the lineal product substrate is formed, it is pre-heated in-line using an oven, such as an IR oven. A high-melt-temperature cross-linkable polymer is then applied onto the lineal product substrate inline via a cross-head extrusion die. Subsequently, the product passes through an inline oven to cure the thermoset polymer and bond it to the substrate. As a result, a structural lineal component with a durable finish and/or detail features is produced in a continuous inline process with reasonable speed and economy. One embodiment illustrates applying a uniform, thin, zero-VOC thermoset finish or detail shape to a lineal product.

Some embodiments provide for being able to apply a finish, cap, shape, detail feature, or coating that is simultaneously resistant to heat, solvent, scratching, and is zero-VOC. Some embodiments provide an in-line finishing system that has zero VOCs, no waste or overspray, and a cross-linked or thermoset polymer matrix on the finished product. Using a thermoset system is generally known to be advantageous in comparison to thermoplastic or noncross-linked coating systems in regards to durability, temperature exposure, and solvent attack.

The methods discussed herein for a pultruded product are also applicable to other continuously formed line-production lineal products. For example, the production line of FIG. 1 can be modified to lineal substrates by methods such as extrusion or roll-forming.

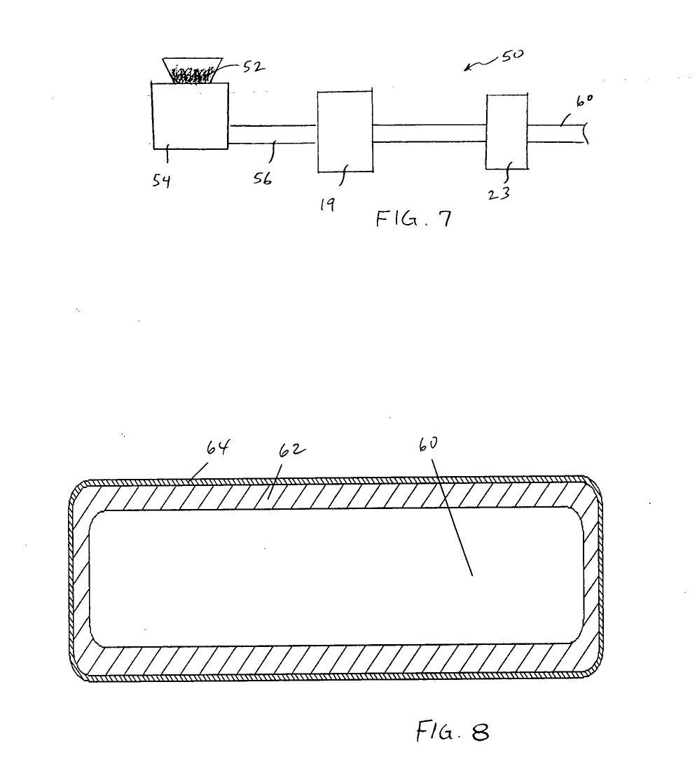

FIG. 7 is a schematic view of an extrusion production line 50 that can be used to produce a thermoset finish or detail feature on a lineal product in accordance with one embodiment. Extrusion is a process that forces a molten material 52 (plastic or metal) through a die 54 to create a continuous profile shape product 56 with a contour cross section. In this embodiment an application device 19, such as discussed above, applies a thermoset finish or detail feature to product 56. In one embodiment, after leaving device 19, the uncured thermoset material enters a curing oven 23, such as discussed above, and a finished product 60, is formed. In some embodiments, a pre-heat oven, such as oven 18 (FIG. 1) can be used prior to application device 19.

FIG. 8 is as cross-section profile view of extruded product 60 in accordance with one embodiment. Product 60 includes an extruded substrate 62 and a thermoset finish 64. In some embodiments, substrate 60 can include an extruded thermoplastic polymer. In some embodiments substrate 60 can include an extruded metal. In one embodiment, thermoset finish 64 includes a zero-VOC thermoset finish.

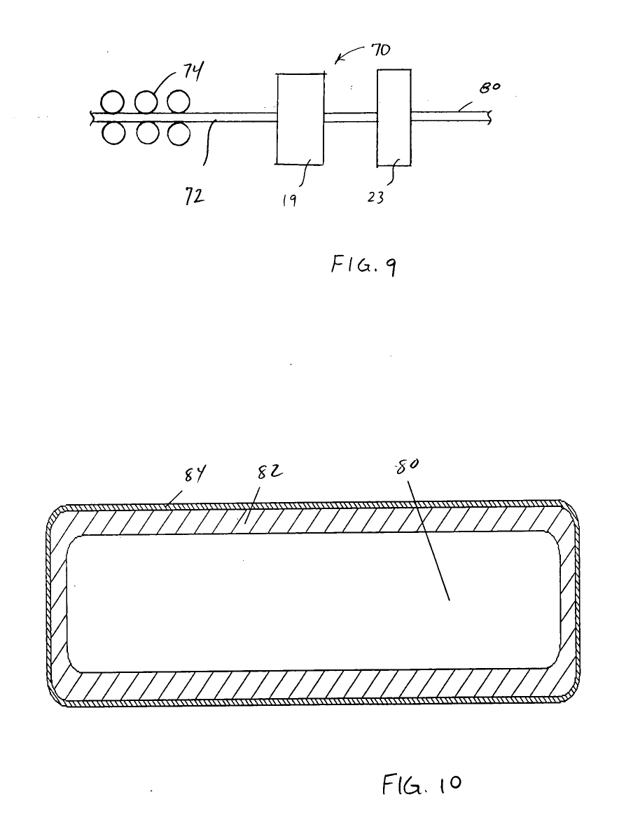

FIG. 9 is a diagrammatic view of a roll-forming production line 70 that can be used to produce a thermoset finish or detail feature on a lineal product in accordance with one embodiment of the present invention. Roll-forming is a process that takes metal 72 through a series of formers 74 to create a continuous profile shape. In this embodiment an application device 19, such as discussed above, applies a thermoset finish or detail feature to product 72. In one embodiment, after leaving device 19, the uncured thermoset material enters a curing oven 23, such as discussed above, and a finished product 80, is formed. In some embodiments, a pre-heat oven, such as oven 18 (FIG. 1) can be used prior to application device 19.

FIG. 10 is as cross-section profile view of a product 80 in accordance with one embodiment. Product 80 includes a roll-formed metal substrate 82 and a thermoset finish 84. In one embodiment, thermoset finish 84 includes a zero-VOC thermoset finish.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method comprising:
forming a lineal substrate in a production line;
die-applying a thermoset finish to a surface of the lineal substrate inline; and
curing the thermoset finish inline so as to bond the thermoset finish to the surface of the lineal substrate.

2. The method of claim 1, wherein forming a lineal substrate includes forming a composite by pultrusion.

3. The method of claim 2, wherein forming a composite includes pulling wetted fiberglass fibers through a forming die.

4. The method of claim 2, wherein die-applying the thermoset finish includes cross-head extruding a thermoset material onto the composite.

5. The method of claim 2, wherein the thermoset finish is cured inline with one or more of the following: infrared radiation, near-infrared radiation, ultraviolet radiation, E-beam radiation and/or convection heat.

6. The method of claim 2, wherein the thermoset finish defines detail features having a different profile than a profile of the lineal substrate.

7. The method of claim 2, wherein the thermoset finish follows the contours of the lineal substrate.

8. The method of claim 2, wherein the thermoset finish encompasses the entire exterior surface of the lineal substrate.

9. The method of claim 2, wherein the thermoset finish encompasses discrete regions of exterior surface of the lineal substrate.

10. The method of claim 1, wherein the thermoset finish includes a zero-VOC thermoset material.

11. The method of claim 1, wherein forming the lineal substrate includes extruding a thermoplastic polymer.

12. The method of claim 1, wherein forming the lineal substrate includes extruding a metal.

13. The method of claim 1, wherein forming the lineal substrate includes roll-forming a metal.

14. The method of claim 1, wherein die-applying the thermoset finish produces no waste byproducts or excess of finishing material.

15. A product comprising:
a pultruded composite; and
a die-applied, thermoset finish covering at least a portion of an outer surface of the pultruded composite.

16. The product of claim 15, wherein the thermoset finish includes a zero-VOC thermoset material.

17. The product of claim 15, wherein the thermoset finish is bonded to the outer surface of the pultruded composite.

18. The product of claim 15, wherein the thermoset finish defines detail features of a final lineal product having a different profile than a profile of the pultruded composite.

19. The product of claim 15, wherein the thermoset finish follows the contours of the pultruded composite and does not define detail features of a final lineal product.

20. A product comprising:
an extruded thermoplastic polymer; and
a die applied, zero-VOC thermoset finish bonded to said extruded thermoplastic.

21. A product comprising:
an extruded metal; and
a die applied, zero-VOC thermoset finish bonded to said extruded metal.

22. A product comprising:
a roll-formed metal; and
a die applied, zero-VOC thermoset finish bonded to said roll-formed metal.
